(19) United States
(12) Patent Application Publication
(10) Pub. No.: US 2015/0356489 A1
(43) Pub. Date: Dec. 10, 2015

(54) Behavior-Based Evaluation Of Crowd Worker Quality

(71) Applicant: MICROSOFT CORPORATION, Redmond, WA (US)

(72) Inventors: Gabriella Kazai, Bishop's Stortford (GB); Imed Zitouni, Bellevue, WA (US); Steven Shelford, Vancouver (CA); Jinyoung Kim, Bellevue, WA (US)

(21) Appl. No.: 14/297,619

(22) Filed: Jun. 5, 2014

(51) Int. Cl. G06Q 10/06

(52) U.S. Cl. CPC G06Q 10/06398

(57) ABSTRACT

Results, generated by human workers in response to HITs assigned to them, are evaluated based upon the behavior of the human workers in generating such results. Workers receive, together with an intelligence task to be performed, a behavior logger by which the worker's behavior is monitored while the worker performs the intelligence task. Machine learning is utilized to identify behavioral factors upon which the evaluation can be based and then to learn how to utilize such behavioral factors to evaluate the HIT results generated by workers, as well as the workers themselves. The identification of behavioral factors, and the subsequent utilization thereof, is informed by the behavior of, and corresponding results generated by, a trusted set of workers. Results evaluated to have been improperly generated can be discarded or simply downweighted. Workers evaluated to be operating improperly can be removed or retrained.

### BACKGROUND

As an increasing number of people gain access to networked computing devices, the ability to distribute intelligence tasks to multiple individuals increases. Moreover, a greater quantity of people can be available to perform intelligence tasks, enabling the performance of such tasks in parallel to be more efficient, and increasing the possibility that individuals having particularized knowledge or skill sets can be brought to bear on such intelligence tasks. Consequently, the popularity of utilizing large groups of disparate individuals to perform intelligence tasks continues to increase.

The term “crowdsourcing” is often utilized to refer to the distribution of discrete tasks to multiple individuals, to be performed in parallel, especially within the context where the individuals performing the task are not specifically selected from a larger pool of candidates, but rather those individuals individually choose to provide their effort in exchange for compensation. Existing computing-based crowdsourcing platforms distribute intelligence tasks to human workers, typically through network communications between the computing devices implementing such crowdsourcing platforms, and each human worker's individual computing device. Consequently, the human workers performing such intelligence tasks can be located in diverse geographic regions and can comprise diverse educational and language backgrounds. Furthermore, the intelligence tasks that such human workers are being asked to perform are typically those that do not lend themselves to easy resolution by a computing device, and are, instead, tasks that require the application of human judgment. Consequently, it can be difficult to verify that the various diverse and disparate human workers, over which there is little control, are properly performing the intelligence tasks that have been assigned to them.

One mechanism for improving the quality of the results generated for intelligence tasks that have been crowdsourced to an undefined set of workers is to utilize intelligence tasks for which definitive answers or results have already been determined and established. Such intelligence tasks can then be utilized in a variety of ways, including to detect incompetent or disingenuous workers, such as those who are simply providing random results in order to receive compensation for as great a quantity of human intelligence tasks as possible within a given period of time, without regard to the quality of the results being provided. Without double-checking mechanisms, such as those utilizing intelligence tasks for which definitive answers have already been determined, workers that are repeatedly providing incorrect results could avoid detection and negatively influence the performance of a set of intelligence tasks. Unfortunately, the generation of a set of intelligence tasks and corresponding definitive answers can be tedious and time-consuming, as well as expensive, since it can require the input of specialists whose time and skills are substantially more expensive than the workers to whom such intelligence tasks are being crowdsourced. Additionally, intelligence tasks with definitive answers can provide only limited double-checking capabilities and costs are incurred every time such intelligence tasks with definitive answers are issued to workers in order to check such workers' reliability.

### SUMMARY

In one embodiment, the quality of workers can be evaluated based upon the behavior of those workers in generating results. A worker can receive, together with an intelligence task to be performed, a behavior logger or other like mechanism by which the worker's behavior can be monitored while the worker is performing the intelligence task. Upon the worker's completion of the intelligence task, the worker's behavior, as logged by behavior logger, can be made available together with the intelligence task result generated by the worker. The quality of the result can then be evaluated based upon the logged behavior of the worker in generating such a result.

In another embodiment, the evaluation of the quality of a human worker, can be further informed by logged behavior of reference workers who can be known or trusted in advance to solve intelligence tasks in a proper and correct manner. Such an evaluation can be based on machine learning algorithms, a statistical analysis of the logged behavior of regular workers as compared with trusted, workers, or other comparative mechanisms.

In yet another embodiment, behavior-based evaluation of workers and the results they generate can utilize machine learning algorithms to both identify behavioral factors on which to base a behavior-based evaluation, and also to utilize such behavioral factors in making an evaluation, such as classifying workers into reliable or unreliable groups or predictvely generating their reliability scores using regression techniques.

In a further embodiment, an evaluation of a specific worker can be based on an analysis of the behavior of such a worker while performing multiple, different intelligence tasks, thereby enabling the detection of trends or statistically significant behavioral data points.

In a still further embodiment, a behavior-based evaluation of results can accept or reject the results based on the evaluation. Alternatively, the behavior-based evaluation of results can assign weightings to the results based on the evaluation, thereby enabling subsequent consideration of a greater range of results.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system for evaluating the results of HITs based upon the behavior of human workers in generating such results.

FIG. 2 is a block diagram of an exemplary set of components for evaluating the results of HITs based upon the behavior of human workers in generating such results.

FIG. 3 is a flow diagram of an exemplary evaluation of the results of HITs based upon the behavior of human workers in generating such results; and

FIG. 4 is a block diagram of an exemplary computing device.

### DETAILED DESCRIPTION

The following description relates to the evaluation of human workers based upon the behavior of the human workers in generating results to Human Intelligence Tasks (“HITs”) assigned to them. A worker can receive, together with an intelligence task to be performed, a behavior logger or other like mechanism by which the worker's behavior can be monitored while the worker is performing the intelligence task. Upon the worker's completion of the intelligence task, the quality of the result can be evaluated based upon the logged behavior of the worker in generating such a result. Machine learning can be utilized to both identify behavioral factors upon which the evaluation can be based, including using feature engineering or Bayesian modeling of observable and latent behavior factors and the like, and to perform the evaluation itself based on such factors, such as by using learning algorithms. Behavior-based evaluation can be further informed by the logged behavior of reference workers who can be known or trusted in advance to solve such HITs in a proper and correct manner. Additionally, an evaluation of a worker can be based on multiple HIT results generated by such a worker, thereby enabling the detection of trends or statistically significant behavioral data points.

The techniques described herein focus on crowdsourcing paradigms, where HITs are performed by human workers, from among a large pool of disparate and diverse human workers, who choose to perform such HITs. However, such descriptions are not meant to suggest a limitation of the described techniques. To the contrary, the described techniques are equally applicable to any human intelligence task processing paradigm, including paradigms where the human workers to whom HITs are assigned are specifically and individually selected or employed to perform such HITs. Consequently, references to crowdsourcing, and crowdsource-based human intelligence task processing paradigms are exemplary only and are not meant to limit the mechanisms described to only those environments.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

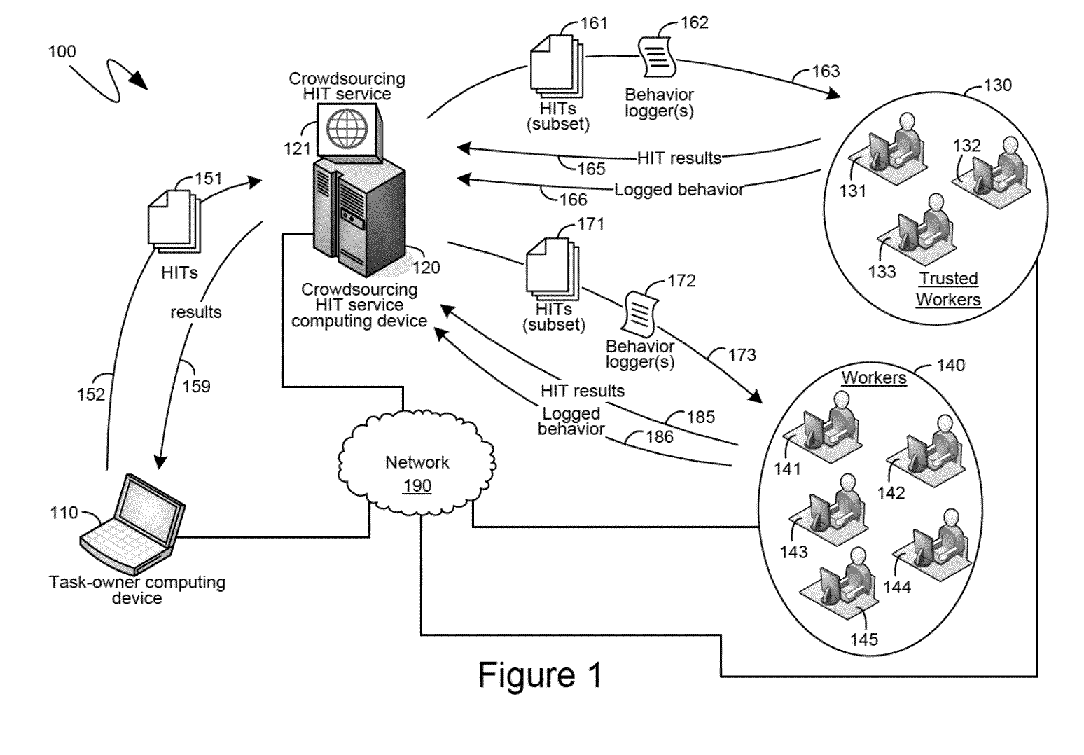

With reference to FIG. 1, an exemplary system 100 is illustrated, providing context for the descriptions below. As illustrated in FIG. 1, the exemplary system 100 can comprise a set of human workers 140, including the illustrated human workers 141, 142, 143, 144 and 145, and a trusted set of human workers 130, including the illustrated trusted human workers 131, 132 and 133. As utilized herein, the term “trusted worker” means any worker that is known in advance to possess both the requisite knowledge or skill to correctly answer the human intelligence task directed to them and the intent to properly apply such knowledge or skill to answer the human intelligence task in accordance with their abilities. Although illustrated as separate sets in the exemplary system 100 of FIG. 1, in other embodiments the trusted human workers 130, including the exemplary trusted human workers 131, 132 and 133, can be part of the human workers 140. Additionally, the exemplary system 100 of FIG. 1 can further comprise a crowdsourcing service 121 that can be executed by one or more server computing devices, such as the exemplary server computing device 120, and a task owner computing device, such as the exemplary task owner computing device 110 by which a task owner can interface with the crowdsourcing service 121 and can utilize the crowdsourcing service 121 to obtain performance of human intelligence tasks by the human workers 140. The one or more server computing devices on which the crowdsourcing service 121 executes need not be dedicated server computing devices, and can, instead, be server computing devices executing multiple independent tasks, such as in a cloud-computing paradigm. Only a single exemplary server computing device 120 is illustrated to maintain graphical simplicity and legibility, but such an exemplary server computing device 120 is meant to represent one or more dedicated or cloud-computing server computing devices. The task owner computing device 110, the server computing devices on which the crowdsourcing service 121 executes, such as exemplary server computing device 120, and the computing devices of the trusted human workers 130 and human workers 140 can exchange computer-readable messages and can otherwise be communicationally coupled to one another through a network, such as the exemplary network 190 shown in FIG. 1.

Initially, as illustrated by the exemplary system 100 of FIG. 1, a task owner can upload HITs, such as the exemplary HITs 151, to the crowdsourcing service 121, as represented by the communication 152 from the task owner computing device 110 to the exemplary server computing device 120 on which the crowdsourcing service 121 is executing. As will be recognized by those skilled in the art, and as utilized herein, the term “human intelligence task” (HIT) means a task whose result is to be generated by the application of human intelligence, as opposed to programmatic or machine intelligence. As will also be recognized by those skilled in the art, HITs are typically tasks that require the application of human evaluation or judging. For example, one intelligence task can be a determination of whether one specific web page is, or is not, relevant to one specific search term. Thus, a human worker performing such an intelligence task could be presented with a webpage directed to, for example, the aurora borealis, and a specific search term, such as, for example, “northern lights”, and such a human worker could be asked to determine whether or not the presented webpage is responsive to the presented search term.

An overall task can be composed of a myriad of such individual HITs. Consequently, returning to the above example, the task, owned by the task owner, that is comprised of such individual HITs, can be a determination of whether or not a collection of webpages is relevant to specific ones of a collection of search terms.

Typically, the crowdsourcing service 121, in response to the receipt of a task from a task owner, would provide the individual HITs, such as the exemplary HITs 151, to one or more of the workers 140 and receive therefrom results generated by such workers 140 in response to the HITs provided to them. The crowdsourcing service 121 would then, typically, return such results to the task owner, such as via the communication 159, shown in FIG. 1.

To return more accurate results to the task owner, such as via the communication 159, the crowdsourcing service 121 can implement mechanisms to provide at least some measure of assurance that the results of the HITs being provided by the workers 140 are accurate. Typically, as indicated previously, such mechanisms relied on “gold HITs”, which were HITs for which an answer or result that was considered to be the correct answer or results for such HITs was already known. Such gold HITs could then be provided to various ones of the workers 140 and the results generated by those workers could be compared to the known correct results in order to determine whether those workers were performing the HITs properly. However, as also indicated previously, such mechanisms are expensive to implement, since the generation of gold HITs required specialized workers and other costly overhead. Additionally, as also indicated previously, such mechanisms are limited in their capabilities to detect workers who were not performing HITs properly, since the only workers that could be evaluated with such gold HITs are the ones to which such gold HITs are actually provided within the course of the performance of a task by the collection of workers 140. Furthermore, each assigning of a gold HIT to a worker to evaluate such a worker's performance incurs a cost to the task owner.

In one embodiment, therefore, in order to evaluate a greater proportion of the results generated by workers in the performance of a crowdsourced task, a crowdsourcing service, such as the exemplary crowdsourcing service 121, can implement mechanisms by which the results generated by workers, and the workers themselves, can be evaluated based upon the behavior of such workers in generating such results. As will be recognized by those skilled in the art, HITs can be performed by workers interacting with processes executing on the workers' local computing devices, or by workers interacting with processes executing on remote computing devices, such as those hosing the crowdsourcing service 121. In the former case, as illustrated by the communication 173, the crowdsourcing service 121 can provide, to the workers 140, not only the HITs 171 that are to be performed by the workers 140, but also behavior loggers 172 that can monitor and log the behavior of the workers 140 in solving the HITs 171. The workers 140 can then return, as illustrated by the communication 185, the results of the HITs 171 that were provided to them. Additionally, the behavior loggers 172 can return, as illustrated by the communication 186, logged behavior of the workers 140 corresponding to the solving, by the workers 140, of the HITs 171 and generating the results that are shown as provided via the communication 185. In the latter case, since the workers 140 would be interacting with processes executing at the crowdsourcing service 121 itself, the results of the HITs and the logged behavior need not be explicitly communicated back to the crowdsourcing service 121. Instead, in such implementations, the communications 173, 185 and 186 are merely conceptualizations of information transfer, as opposed to explicit network data communications.

The nature of the behavior loggers 172 can be in accordance with the manner in which the HITs 171 are provided to the workers 140. For example, if the communication 173, providing the HITs 171 to the workers 140, comprises making available, to the workers 140, a webpage or other like formatted collection of data that the workers 140 issue explicit requests to receive, then the behavior loggers 172 can comprise scripts or other like computer-executable instructions, including computer-interpretable instructions, that can execute on the computing devices utilized by the workers 140 to explicitly request, and subsequently receive, the HITs 171. As another example, if the HITs 171 are provided to the workers 140 by transmitting a package to the workers 140 that comprises specialized computer-executable instructions that can execute on the computing devices of the workers 140 to generate a context within which the workers 140 perform the intelligence tasks assigned them, then the behavior loggers 172 can be integrated into such a package. In such an example, the behavior loggers 172 can be integrated with the HITs 171 and the communication 173 can comprise a single communication. Consequently, while the exemplary system 100 of FIG. 1 illustrates the HITs 171 and the behavior loggers 172 as being separate items, such an illustration is merely for ease of visualization and conceptualization, as opposed to an explicit indication of the packaging of the aforementioned components. Additionally, there need not exist an explicit one-to-one relationship between behavior loggers 172 and HITs 171. For example, a single behavior logger 172 can be transmitted to each individual worker, of the workers 140, irrespective of the quantity of HITs assigned to, retrieved by, or performed by such a worker. In such an example, the single behavior logger 172 can log the behavior of the worker, in performing each individual intelligence task, and can return the logged behavior, such as via communication 186, separately for each individual intelligence task, or can return an aggregate behavior log comprising the behavior of the worker in the performance of multiple HITs.

The behavior of a worker performing an intelligence task that can be logged by the behavior loggers 172 can be dependent upon the computing device upon which such a worker is performing the HIT. For example, if the user is utilizing a common desktop computing device comprising a mouse, or other like user input device controlling the cursor, then the behavior loggers 172 can logged behavior including, for example, the movements and clicks of the mouse made by the worker during the performance of the HIT. More specifically, the behavior loggers 172 can log any one or more of the following information while the worker is performing the intelligence task: mouse movements and clicks, scrolling, window focus event, window movement event, copy and paste events, etc. From these, a wide range of behavior features may be obtained, such as the aggregate quantity of mouse movement events by a given worker over a given unit of time and for specific HITs, the dwell times between mouse movement events, the time between when the intelligence task is first loaded, or viewed, by the worker and the first mouse movement, the aggregate quantity of mouse clicks, the quantity of mouse clicks per unit time, the dwell times between mouse clicks, the time between when the intelligence task is first loaded, or viewed, by the worker and the first mouse click, the quantity of resources or links clicked on, the time spent viewing a set of data after clicking on a link to call up that set of data, the quantity of scrolling events, the quantity of window resize events, the quantity of copy/paste events and other like behavioral information derivable from user input monitoring. As will be recognized by those skilled in the art, analogous information can be logged by behavior loggers executing in a computing context where user input is provided through touchscreen devices, such as the ubiquitous tablet and smartphone computing devices.

As will be described in further detail below, an analysis of such logged behavior can reveal which intelligence task results may not be the result of properly operating human workers and may be, instead, the product of unscrupulous or malicious workers that, for example, seek to generate results for HITs as quickly as possible, without regard to correctness, so as to maximize the revenue generated therefrom, or for other malicious purposes. By way of a simple example, if the logged behavior reveals that a result was generated by a worker without any mouse movement events or mouse clicks, while the average of the workers 140, in generating results to analogous HITs, was dozens of mouse movement events and several mouse clicks, then a conclusion can be made that the result corresponding to such logged behavior can be an incorrect, or improperly derived result. Consequently, in one embodiment, the analysis of logged behavior can be based on a comparison between the logged behavior corresponding to a specific intelligence task result, generated by a specific worker, and the logged behavior of others of the workers 140 while performing analogous HITs.

In another embodiment, trusted workers, such as the exemplary trusted workers 130, can be utilized to provide a meaningful baseline against which to compare the logged behavior of the workers 140 as they generate results for various ones of the HITs assigned to them. More specifically, and as illustrated in the exemplary system 100 of FIG. 1, the crowdsourcing service 121 can, in such an embodiment, provide one or more HITs, such as exemplary HITs 161, to one or more of the trusted workers 130. The trusted workers 130, like the workers 140, can interact with processes executing on their local computing devices to generate results for the HITs assigned to them, or they can interact with processes executing remotely, such as on the computing devices hosting the crowdsourcing service 121. In the former instance, the HITs 161 can be communicated to the trusted workers 130, such as via the communication 163, and, as with the exemplary communication 173, described in detail above, the exemplary communication 163 can further comprise the delivery of one or more behavior loggers, such as the exemplary behavior loggers 162, that can monitor the behavior of the trusted workers 130 in performing the HITs 161. In the latter instance, since the processes with which the trusted workers 130 will be interacting are executing with the processes of the crowdsourcing service 121, communication 163, and responsive communications 165 and 166, need not represent network data communications, but rather can represent conceptualizations of information transfer. As in the case of the behavior loggers 172, the delivery of the behavior loggers 162 can be dependent upon the manner in which the HITs 161 are communicated to the trusted workers 130. For example, if the HITs 161 are provided to the trusted workers 130 via a web page, or other like collection of information and data that is accessible via network communications, then the behavior loggers 162 can be scripts or other like computer-executable instructions that are to be provided with the webpage, and which can then be executed locally on the computing devices being utilized by the trusted workers 130 to generate results for the HITs 161. As another example, if the intelligence tasks 161 are provided by transmitting a package to the trusted workers 130 that comprises specialized computer-executable instructions that can execute on the computing devices of the trusted workers 130 to generate a context within which the trusted workers 130 generate results for the HITs 171, then the behavior loggers 162 can be integrated into such a package. As before, the behavior loggers 162 can be integrated with the HITs 161 and the communication 163 can comprise a single communication. Alternatively, the single communication 163 shown in FIG. 1 can be merely illustrative of multiple discrete communications transmitting separately the HITs 161 and the behavior bloggers 162. Additionally, a single behavior logger 162 can log the behavior of a trusted worker in performing multiple individual HITs, and can return the logged behavior, such as via communication 166, separately for each individual intelligence task, or can return an aggregate behavior log comprising the behavior of the worker in the performance of multiple HITs.

As illustrated in the system 100 of FIG. 1, the trusted workers 130 can generate results for the HITs 161 assigned to them, and such results can be returned to the crowdsourcing service 121, such as via the exemplary communication 165. Similarly, as indicated previously, behavior logs collected by the behavior logger 162 can, likewise, be returned to the crowdsourcing service 121 via the exemplary communication 166. In one embodiment, the crowdsourcing service 121 can utilize the results provided via the communication 165 and the behavior logs provided via the communication 166 to more accurately evaluate the results provided from the workers 140, such as via the exemplary communication 185. More specifically, information obtained from the trusted workers 130 can guard against a bias being introduced into the evaluation of results from the workers 140 that is based on the composition of the workers 140 themselves.

As indicated previously, in one embodiment, the evaluation of the results provided by the workers 140 can be based on an analysis of the behavior of each individual worker, in generating an individual result, as compared with metrics derived from the logged behavior of multiple ones of the workers 140 as a group. However, it can be possible that the workers 140 comprise an unexpectedly large quantity of unscrupulous workers that are providing results without regard to correctness, and, for example, merely to collect as much revenue as possible. In such an instance, the large quantity of such unscrupulous workers can skew behavioral data away from that generated by proper workers seeking to correctly generate results for the HITs assigned to them.

In one embodiment, therefore, the crowdsourcing service 121 can utilize the behavior of the trusted workers 130 to more accurately identify behavioral patterns and data that can be utilized to evaluate workers and the results they generate. For example, analysis of the behavior of the trusted workers 130, in generating HIT results, can reveal that, as one example, on average, each worker generated several mouse click events while solving an individual intelligence task assigned to such a worker. In such an example, then, a result from one of the workers 140 can be evaluated based upon a comparison between the quantity of mouse click events that such a worker generated in solving the intelligence task for which that worker provided a result, and the average quantity of mouse click events generated by the trusted workers 130. If, for example, a result is provided by one of the workers 140, and the corresponding logged behavior indicates that such a user generated no mouse click events in resolving the HIT, then a comparison between such logged behavior and the average behavior of a trusted worker can be utilized to evaluate such a result and determine that such a result is likely improper.

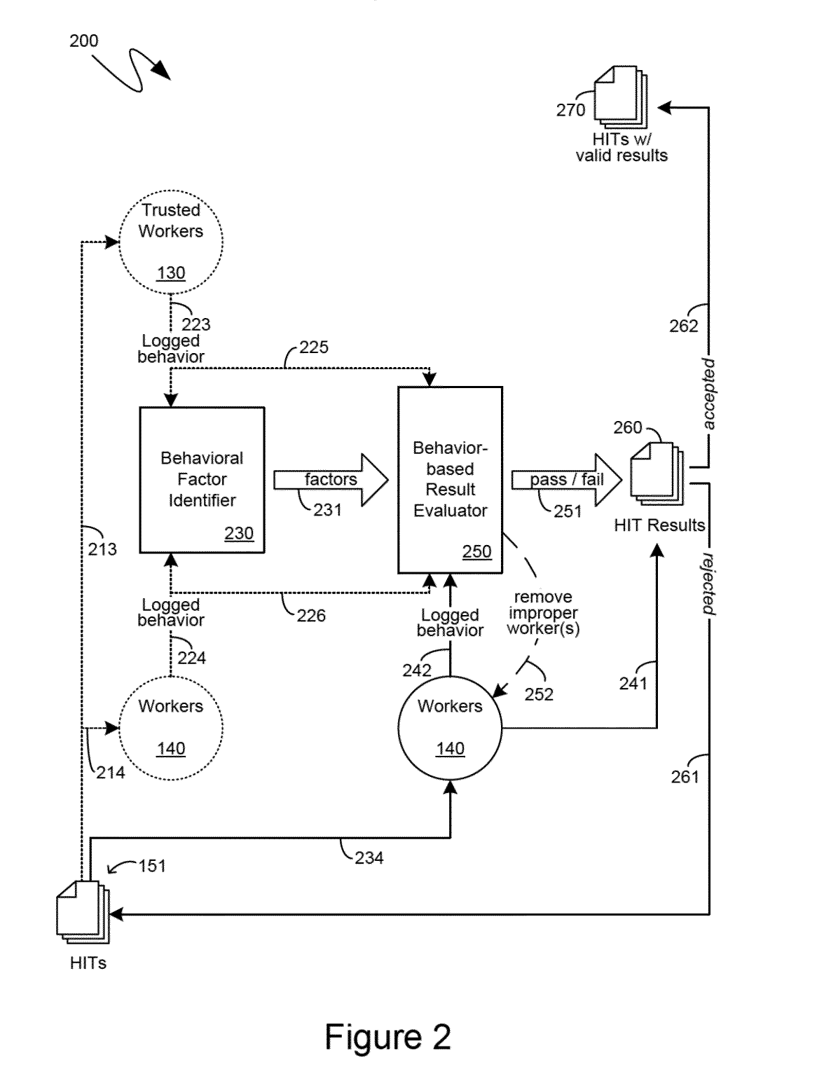

Turning to FIG. 2, the system 200 shown therein illustrates an exemplary mechanism for evaluating the results of HITs based upon the behavior of a human user generating the result. During one phase, illustrated in FIG. 2 by dotted lines, some of the HITs 151 can be assigned to the workers 140, as illustrated by the communication 214. As described in detail above, the behavior of the workers 140, in performing the HITs assigned to them, can be logged by behavior loggers, and such logged behavior can be provided to a behavioral factor identifier 230, as illustrated by the communication 224. Optionally, some of the HITs 151 can be assigned to the trusted workers 130, as illustrated by the communication 213. As also described in detail above, the behavior of the trusted workers 130, in performing the HITs assigned to them, can be logged by behavior loggers, and such logged behavior can, optionally, be provided to the behavioral factor identifier 230, as illustrated by the communication 223.

The behavioral factor identifier 230 can utilize machine learning, statistical analysis, heuristic analysis, regression analysis, and other analytic algorithms and mechanisms to identify factors 231, from among the logged behavior 224 and, optionally, the logged behavior 223, upon which workers, and the HIT results they generate, can be evaluated. In one embodiment, the behavioral factor identifier 230 can detect statistical deviations in the logged behavior 224, from the workers 140, and can identify the corresponding logged behavior as one of the factors 231 upon which the behavior-based result evaluator 250 can evaluate results of HITs. For example, the logged behavior 224 can indicate that the workers 140, in performing intelligence tasks, generated ten mouse click events on average. The logged behavior 224 can further indicate that the quantity of mouse click events generated by individual workers, in performing individual HITs assigned to them, clusters around the average of ten mouse click events with a standard deviation of two. The logged behavior 224 can also comprise logged behavior from some of the workers 140 which indicates that those workers were able to perform an intelligence task, as an example, without generating any mouse click events. In such a simplified example, the behavioral factor identifier 230 can detect the aberration in the logged behavior indicative of no mouse click events, and can determine that a quantity of mouse click events can be one of the factors 231 upon which the behavior-based result evaluator 250 can evaluate HIT results having corresponding behavior logs.

The behavior-based result evaluator 250 can then, when receiving logged behavior 242, from one of the workers 140, corresponding to a specific HIT result, utilize such behavioral factors 231, identified by the behavioral factor identifier 230, to evaluate the corresponding HIT result from among the HIT results 260. More specifically, one of the HITs 151 can be assigned to one of the workers 140, as illustrated by the communication 234. Such a worker can generate a corresponding HIT result, as illustrated by the communication 241. Additionally, such as in the manner described in detail above, the behavior of such a worker in performing the intelligence task can be collected and logged, and such logged behavior 242 can be provided to the behavior-based result evaluator 250. The behavior-based result evaluator 250 can evaluate the intelligence task result corresponding to the logged behavior based upon at least some of the behavioral factors 231. In one embodiment, the behavior-based result evaluator 250 can utilize machine learning algorithms, statistical analysis or other comparative or analytic mechanisms to determine threshold values, acceptable ranges, and other like quantitative aspects of the behavioral factors 231 upon which the behavior-based result evaluator 250 can identify HIT results that may have been generated improperly, that may be “spam” or otherwise inaccurate, or to identify low quality workers. More specifically, like the behavioral factor identifier 230, the behavior-based result evaluator 250 can take into account prior logged behavior, such as that represented in FIG. 2 by the prior logged behavior 226, as well as prior logged behavior from trusted workers, such as that represented in FIG. 2 by the behavior 225. In such a manner, as will be described in further detail below, the behavior-based result evaluator 250 can learn the relationships between different ones of the behavioral factors 231, can identify the aforementioned quantitative aspects of such behavioral factors 231 upon which to craft an evaluation, can derive groupings of workers with similar behavior or similar classifications, or can otherwise evaluate workers and the HIT results they generate based on the behavior of such workers in generating such results.

Determinations of the behavior-based result evaluator 250 are graphically illustrated in the exemplary system 200 of FIG. 2 as the pass/fail determination 251. As illustrated, if the behavior-based result evaluator 250 determines that one or more of the HIT results 260 pass, then such results are accepted, as illustrated by the communication 262, and are retained in the collection of HITs with valid results 270. Conversely, if, the behavior-based result evaluator 250 determines that one or more of the intelligence task results 260 fail, then the corresponding HITs can, in one embodiment, be returned back to the HITs 151, as illustrated by the communication 261, and are then, subsequently, provided anew to other workers among the workers 140. In other embodiments, the corresponding HITs can be removed from the HITs 151 as potentially confusing or improperly formed HITs, or, in yet another embodiment, as will be described in further detail below, the HIT results can be downweighted but nevertheless included in the collection of HITs with valid results 270. Such downweighting can, for example, be in proportion to the worker's reliability such as would be done by the Expectation Maximization method or similar algorithms and machine learning methods.

In one embodiment, the factors 231, generated by the behavioral factor identifier 230, can be specific to a given task, or type of task. For example, if the HITs 151 are part of a task directed to determining whether a set of search results are relevant to a query, then the factors 231 can equally be utilized by the behavior-based result evaluator 250 to evaluate the results of a different HIT that is directed to determining whether a different set of search results are relevant to a different query. Consequently, the generation of the factors 231, such as by the behavioral factor identifier 230, can be an optional step, since the factors 231 previously generated within the context of an analogous task can remain valid for a current task and can, consequently, be reused.

In another embodiment, the factors 231, generated by the behavioral factor identifier 230, can be task-independent. As such, the factors 231, generated by the behavioral factor identifier 230 within the context of, for example, a task directed to determining whether a set of search results are relevant to a query can be applicable within the context of other tasks such as, for example, a task directed to determining which of two or more search results are more relevant, or a task directed to ranking the relevance of two or more search results. As before, therefore, the generation of the factors 231, such as by the behavioral factor identifier 230, can be an optional step even in situations where an analogous or equivalent task has not previously been processed, since the factors 231 that were previously generated during the prior performance of non-analogous tasks can, potentially, be reutilized.

As described previously, trusted workers, such as exemplary trusted workers 130, can, optionally, be utilized to aid in the identification of the factors 231. In one embodiment, the trusted workers 130, in solving the HITs 151 that are assigned to them, as illustrated by the communication 213, can generate the logged behavior 223, which can be provided as input to the behavioral factor identifier 230. In another embodiment, although not specifically illustrated in the system 200 of FIG. 2, the HIT results generated by the trusted workers 130 can also be considered by the behavioral factor identifier 230 to be able to more accurately identify factors 231. More specifically, and as will be described in detail below, in such an embodiment, the behavioral factor identifier 230 can take into account whether an intelligence task result is objectively correct when determining which behavior factors are to be utilized to evaluate subsequent intelligence task results.

Turing to the former embodiment first, the logged behavior 223, received from the trusted workers 130, can provide more insightful guidance as to what types of behavior are appropriately flagged as the factors 231 that are to be considered by the behavior-based result evaluator 250. More specifically, the logged behavior 223, received from the trusted workers 130, can be analyzed with a predetermination that the logged behavior 223 is indicative of proper behavior in correctly performing an intelligence task. For example, returning to the above simplified example where the logged behavior 224, from the workers 140, enabled the behavioral factor identifier 230 to identify, as one of the factors 231, a quantity of mouse click events generated during the performance of an intelligence task, if the logged behavior 223, from the trusted workers 130, showed that some of the trusted workers 130 were able to resolve some of the HITs assigned to them without generating a single mouse click, then the behavioral factor identifier 230 could determine that a quantity of mouse click events may not be an appropriate one of the factors 231 because, based upon the logged behavior 223, it can be determined that a lack of mouse click events is as legitimate as the generation of multiple mouse click events and, as such, HIT results may not be able to be meaningfully evaluated based upon a quantity of mouse click events generated during the performance of such a HIT. Conversely, if, for example, staying with the same simplified example, the logged behavior 223 showed that the average quantity of mouse click events generated by the trusted workers was five, with a standard deviation of one, the behavioral factor identifier 230 can determine that a quantity of mouse click events can be a useful one of the factors 231.

The behavior-based result evaluator 250, in one embodiment, can also utilize logged behavior and corresponding HIT results from the trusted workers 130 to determine how to evaluate subsequent HIT results, and the associated workers, based on the behavior of those workers. For example, returning to the above simplified example, if the logged behavior 225, provided to the behavior-based result evaluator 250, showed that the average quantity of mouse click events generated by the trusted workers was five, with a standard deviation of one, the behavior-based result evaluator 250 could determine, based upon such logged behavior 225, that too great a quantity of mouse click events could be indicative of improper intelligence task completion, such as, for example, HITs performed by workers who were randomly clicking to appear busy as indicated by the excessive quantity of mouse click events that they generated. In such an example, commencing from the presumption that the logged behavior 225, from the trusted workers 130, is indicative of proper performance of an intelligence task, the behavior-based result evaluator 250 can determine that, for example, two or more standard deviations from the aforementioned exemplary median of five mouse click events is a meaningful upper boundary even though, as indicated in the previously enumerated example, the logged behavior 226, obtained by the behavior-based result evaluator 250 from the workers 140, can reveal that the average quantity of mouse click events was a meaningfully greater ten mouse click events. As can be seen, therefore, the logged behavior 225, from the trusted workers 130, can reveal biases in the logged behavior 226, from the workers 140, that may have otherwise been undetected.

As indicated previously, in one embodiment, the factors 231, generated by the behavioral factor identifier 230, can be task-independent and can be applicable across different types of tasks. In such an embodiment, a task owner need not necessarily be required to utilize trusted workers, such as the exemplary trusted workers 130, to generate the logged behavior 223. Instead, the factors 231 can have been derived utilizing the logged behavior generated by a prior set of trusted workers from a prior, different, task, including potentially tasks from other task owners.

In another embodiment, as prefaced above, the results generated by the trusted workers 130 can, likewise, be utilized to identify at least some of the factors 231 and how to behaviorally evaluate subsequent HIT results based on such factors 231. More specifically, the results generated by the trusted workers 130 can be treated as the correct results for the corresponding HITs. Consequently, if those same HITs were also assigned to the workers 140, then the logged behavior, and the corresponding results generated by the workers 140, can be compared with the correct results generated by the trusted workers 130 to identify behavioral factors that are either positively, or negatively, correlated to the correctness of the corresponding HIT result. For example, returning to the above simplified example, if the logged behavior 226 indicates that some of the workers 140 generated approximately five mouse click events while resolving an intelligence task, while others of the workers 140 generated approximately 10 mouse click events while resolving an intelligence task, there may not be a sufficient statistical discrepancy between such logged behavior 226 when considered by itself. However, if, in comparison to the intelligence task results provided by the trusted workers 130, the behavior-based result evaluator 250 determines that those of the workers 140 resolving an intelligence task utilizing approximately five mouse click events reached the same results as the trusted workers 130 in resolving the same intelligence task, while those of the workers 140 resolving an intelligence task utilizing approximately ten mouse click events reached different results then those reached by the trusted workers 130 in resolving the same intelligence task, then the behavior-based result evaluator 250 can deduce that, where a quantity of mouse click events is one of the factors 231, a quantity of approximately five mouse click events can be indicative of proper evaluation of an intelligence task, while statistically greater quantities of mouse click events can be indicative of incorrect evaluation of an intelligence task.

In one embodiment, the generation of the factors 231, by the behavioral factor identifier 230, can be a threshold step prior to the utilization of such factors 231 by the behavior-based result evaluator 250 during an operation of the crowdsourcing service. For example, a subset of the HITs 151 can be provided to the workers 140 and, optionally, the trusted workers 130, in order to generate the logged behavior 224 and, optionally, the logged behavior 223, from which the behavioral factor identifier 230 can generate at least some of the factors 231, such as in the manner described in detail above. The communication of some of the HITs 151 to the workers 140, such as via the communication 214, and to the trusted workers 130, such as via the communication 213, as well as the communication of the logged behavior 224, from the workers 140, and the logged behavior 223, from the trusted workers 130, are illustrated in dashed lines in the exemplary system 200 of FIG. 2 to signify that such can be preliminary steps that can cease once at least some of the factors 231 have been established and communicated to the behavior-based result evaluator 250. Consequently, such as during a steady-state operation of the crowdsourcing service, the HITs 151 can be provided, such as via the communication 234, to the workers 140, which can generate results for such HITs and provide those HIT results 260, such as via the communication 241. In addition, as described in detail above, the behavior of the workers 140, in generating the intelligence task results 260, can be logged and such logged behavior 242 can be provided to the behavior-based result evaluator 250.

In one embodiment, the behavior-based result evaluator 250 can evaluate one or more of the results 260 based upon the corresponding behavior as contained in the logged behavior 242, of the worker, from among the workers 140, who generated such a result. The evaluation, by the behavior-based result evaluator 250, can result in a determination 251 as to whether the evaluated result, from among the results 260, is accepted, as illustrated by the acceptance path 262, or is rejected, as illustrated by the rejection path 261. As can be seen from the exemplary system 200 of FIG. 2, if the evaluated result, from among the results 260, is accepted, than the acceptance path 262 illustrates such a result being retained as part of the HITs with valid results 270, which can ultimately be returned to the task owner. Conversely, if the evaluated result, from among the results 260, is rejected, then, in one embodiment, the rejection path 261 illustrates the corresponding intelligence task being returned back to the HITs 151 that still remain to be correctly performed by one of the workers 140. In other embodiments, as indicated previously, and as will be described in further detail below, the rejection path 261 can simply lead to the corresponding HIT being removed from the HITs 151 or, alternatively, that the evaluated result is downweighted or assigned a zero weighting, but is nevertheless included in the HITs with valid results 270 that can, ultimately, be provided to the task owner.

While the above descriptions have been directed to the behavior-based result evaluator 250 evaluating individual HIT results, in other embodiments, mechanisms analogous to those described herein can be utilized by the behavior-based result evaluator 250 to evaluate workers or whole tasks. For example, the behavior-based result evaluator 250 can evaluate an individual worker based on the behavior of such a worker in generating results for one or more HITs. If such a worker is evaluated to be utilizing improper behavior, such a worker can be removed, such as is illustrated by the worker removal action 252, shown in FIG. 2. Conversely, as an alternative, such a worker can be sent for re-training or can be otherwise rehabilitated or have the behavior of such a worker that was deemed improper curtailed or modified. As anther example, the behavior-based result evaluator 250 can evaluate a task on the behavior of such workers in generating results for HITs of such a task. If too many workers are being evaluated as utilizing improper behavior, such can be a determination that the task is improperly or sub-optimally formed, and the task can be returned to the task owner, or can be re-run with a different set of workers.

A number of different mechanisms can be utilized by the behavior-based result evaluator 250 to perform evaluations based upon the behavior of a worker in generating a corresponding result. For example, in one embodiment, such an evaluation can be based on an aggregation of individual evaluations based on individual ones of the factors 231. More specifically, the behavior-based result evaluator 250 can compare one of the identified factors 231 to a corresponding aspect of the logged behavior 242 and can determine a difference between the corresponding aspect of the logged behavior 242 and that one factor of the identified factors 231. Subsequently, the behavior-based result evaluator 250 can compare another one of the identified factors 231 to a corresponding aspect of the logged behavior 242 that is associated with the HIT result being evaluated, and, again, determinate differences between. Subsequently, such differences can be summed to determine an aggregate variation between the behavior of the worker in generating the HIT results being evaluated, as logged and then provided as part of the logged behavior 242, and the factors 231 identified by the machine learning model 230. In one embodiment, if such an aggregate variation is greater than a threshold amount, the behavior-based result evaluator 250 can determine that the corresponding HIT result should be rejected, and that the HIT can be returned to the HITs 151, as illustrated by the rejection path 261. Conversely, if the aggregate variation is less than the threshold amount, the behavior-based result evaluator 250 can determine that the corresponding HIT result appears to have been properly generated, and such a result can be included as part of the HITs with valid results 270 that can, ultimately, be provided to the task owner as an aspect of the completion of the task. In other embodiments, rather than referencing a threshold, the behavior-based result evaluator 250 can, instead, reference differences between distributions or other factors in accordance with the algorithm or machine learning method implemented by the behavior-based result evaluator 250.

By way of a specific, simple, example to further illustrate one exemplary operation of the behavior-based result evaluator 250, the factors 231 can include the aforementioned quantity of mouse click events as well as, for example, a dwell time between when a worker initially received an intelligence task, and the first mouse click event. More specifically, the behavior-based result evaluator 250 can derive, such as through the machine learning algorithms described above, that quantities of less than five mouse click events, or greater than 10 mouse click events, can be indicative of behavior associated with improper results. Similarly, the behavior-based result evaluator 250 can derive that dwell times of less than twenty seconds and greater than two minutes can, likewise, be indicative of behavior associated with improper results. The logged behavior 242, therefore, can include information indicating the behavior of a worker providing a specific one of the intelligence task results 260, namely the quantity of mouse click events that such a worker generated in the performance of a particular intelligence task for which the worker provided a result, as well as the dwell time between when such an intelligence task was first presented to the worker and the worker first generated a mouse click event. If the logged behavior 242 indicates that the worker providing the specific one of the HIT results 260 that is currently being evaluated by the behavior-based result evaluator 250 generated five mouse click events but had a dwell time of only five seconds, the behavior-based result evaluator 250 can aggregate such information and can determine, for example, that the five mouse click events are not necessarily indicative of behavior associated with improper results, but only barely so, in the present example, while the dwell time of only five seconds is substantially lower than a minimum dwell time found to be indicative of proper results, and, consequently, in aggregate, the worker's behavior is indicative of an improper result. Consequently, in such a simplified example, the behavior-based result evaluator 250 can generate an evaluation 251 rejecting the specific one of the intelligence task results that was being evaluated.

In one embodiment, specific ones of the factors 231 can be accorded different weights for purposes of evaluating behavior of a worker generating an intelligence task result. More specifically, some of the factors 231 may not have as strong a correlation to the correctness or propriety of intelligence task results generated by workers exhibiting such behavior. Consequently, those factors can be weighted less than other factors that can have a strong correlation to the correctness of the intelligence task results generated by workers exhibiting such behavior. More specifically, correlation between ones of the factors 231 and the correctness or propriety of HIT results can be analyzed manually, such as by using known statistical correlation evaluation methodologies. Alternatively, such correlation can be automatically learned, such as by a machine learning algorithm. Similarly, the weighting to be applied to specific ones of the factors 231 can be determined through machine learning mechanisms, such as linear regression.

In an alternative embodiment, or in addition, various ones of the factors 231 can be considered by the behavior-based result evaluator 250 by normalizing the logged behavior 242 corresponding to the result being evaluated. Such normalization can be performed by, for example, bucketing logged behavior into discrete buckets, or ranges of values. For example, returning to the above simplified example, quantities of mouse click events can be normalized by being divided, or bucketed, into discrete buckets, where each bucket can, for example, comprise quantities of mouse click events in increments of five. Thus, for example, one bucket of mouse click events can comprise quantities of mouse click events between zero and five, another bucket of mouse click events can comprise quantities of mouse click events between six and ten, and so on. In such an example, the behavior-based result evaluator 250 can evaluate workers' behavior in such a manner that a worker generating no mouse click events is regarded equally, within the context of mouse click event quantity, as a worker generating three mouse click events.

Another mechanism by which workers can be represented, in terms of behavioral features, can be to define buckets, or ranges of values. Such buckets can be based on previously determined acceptable variations, or they can be learnt. As yet another alternative, such buckets may not be previously obtained, because it is also possible to obtain ideal behaviour data, which is only determined as such after the fact, on HITs, where suspicious crowd behavior was expected. In such a manner, workers can be represented in terms of behaviors features based on simple statistics, such as a quantity of mouse clicks per time unit across HITs or based on normalized statistics, which can, colloquially, represent whether the worker is above or below an ideal, slower or faster than an ideal, or other like comparative evaluation. For example, returning to the above example where quantities of mouse click events between five and ten were considered to be indicative of a properly generated HIT result, while behavior resulting in greater or fewer mouse click events was indicative of improperly generated HIT results, one bucket can be defined as comprising quantities of mouse click events between five and ten, while another bucket can be defined as comprising quantities of mouse click events that are too low, namely quantities of mouse click events between zero and five, and another bucket can be defined as comprising quantities of mouse click events that are too high, namely quantities of mouse click events greater than ten.

In evaluating an intelligence task result based upon the behavior of a worker generating such an intelligence task result, the behavior-based result evaluator 250 can, through various mechanisms, such as those described in detail above, aggregate various behavioral factors to reach an ultimate conclusion. Such a conclusion can be based upon whether the aggregated values are greater than, or less than, a predefined threshold. For example, in one embodiment, positive values can be assigned to logged behavior indicative of properly generated HIT results, while negative values can be assigned to logged behavior indicative of improperly generated HIT results. In such an embodiment, a threshold value can be zero, with an aggregation of factors resulting in positive values being indicative of properly generated HIT results, while an aggregation of factors resulting in negative values can be indicative of improperly generated HIT results. In another embodiment, positive values can be assigned to logged behavior, with values closer to zero being indicative of properly generated HIT results, and larger values being indicative of the opposite. In such an embodiment, a threshold value can be a positive value that can be predetermined, or, alternatively, empirically established and continually updated as part of the continued processing of the behavior-based result evaluator 250. Similarly, as illustrated by the feedback of the logged behavior 254, the behavioral factor identifier 230 can continually update the factors 231, the weighting assigned thereto, and the aforementioned threshold value, as additional ones of the logged behavior 242 are received from the workers 140 during the processing of the HITs 151.

In one embodiment, the determination 251, generated by the behavior-based result evaluator 250, rather than being a binary pass/fail determination, can, instead, assign a numerical value, or linguistically descriptive indicator, that can be indicative of a perceived propriety of an HIT result. As indicated previously, such a numerical value can be a weighting to be applied to a HIT result, with results generated by workers whose behavior is indicative of improper HIT resolution being downweighted. For example, a HIT result generated by a worker whose behavior is indicative of improper resolution of the HIT can be assigned a numerical value of zero, or a weighting of zero, thereby indicating that the HIT result should not be utilized or otherwise rendering such a HIT result inconsequential. Conversely, an HIT result generated by a worker whose behavior is indicative of proper resolution of the HIT can be assigned a numerical value of, or a weighting of, for example, one, thereby indicating that the HIT result is very likely valid and that it should be fully weighted. Other HIT results, generated by behavior that is only somewhat indicative of improper resolution of the HITs, such as behavior where some factors of the behavior are indicative of proper worker behavior, while other factors of the behavior indicative of improper work, can be assigned numerical values or weightings between the aforementioned exemplary thresholds of zero and one.

In such an embodiment, where intelligence task results are assigned scores or weightings signifying their evaluation based upon the behavior of the worker in generating a corresponding one of the HIT results, subsequent filtering or classification can be performed to determine which of those HIT results to retain, and which to discard and reassign the corresponding HIT to be performed again, such as by a different worker. By way of a simple example, subsequent filtering can accept only HIT results assigned a score of greater than one-half by the behavior-based result evaluator 250, assuming the aforementioned zero to one scale, with HIT results that were assigned a score or weighting less than one-half being rejected and the corresponding HITs being performed again buy a different worker.

Machine learning can be utilized to tune the filtering or classification of HIT results that were assigned numerical values based on the behavior of the worker generating such results. For example, such machine learning can rely upon statistical analysis to identify appropriate threshold values delineating between HIT results that are to be retained and those that are to be rejected. Other forms of machine learning are equally applicable to such decision-making.

Although the above descriptions have been provided within the context of individual intelligence task results, in another embodiment evaluation of intelligence task results can include the behavior of the worker generating such results over a period of time as evidenced by multiple intelligence task results generated by such a worker. More specifically, in such an embodiment, multiple HIT results 260, such as those from a single one of the workers 140, can be evaluated as a single grouping, with the evaluation 251 being equally applicable to all of such multiple intelligence task results 260. The behavior-based result evaluator 250, in evaluating such multiple intelligence task results 260, can consider factors 231 as applied across the logged behavior 242 corresponding to each of such multiple intelligence task results 260. Thus, rather than considering the factors 231 on a per-result basis, the behavior-based result evaluator 250 can, for example, consider the factors 231 as averaged across all of the multiple HIT results from the same worker that are being considered together. In such an instance, HIT results that happen to be associated with outlier behavior can, nevertheless, be considered to have been properly generated based upon the other HIT results generated by that same worker.

By way of a simple example, if one of the factors 231 is a quantity of mouse click events, and the behavior-based result evaluator 250 will evaluate results having greater than ten mouse click events as likely having been improperly generated, then a single HIT result that was generated by a worker whose behavior included fifteen mouse click events would likely be evaluated, by the behavior-based result evaluator 250, to have been improperly generated. However, if the behavior-based result evaluator 250 was considering multiple HIT results generated by the same worker, and one HIT result was generated by that worker while that worker's behavior included fifteen mouse click events, but the remaining HIT results were generated by that worker with behavior that comprised only between four and six mouse click events, then, on average, such a worker generated HIT results with behavior having meaningfully less than ten mouse click events. Consequently, in considering such an average, or otherwise aggregated value, the behavior-based result evaluator 250 can determine that the worker whose HIT results are being evaluated in a group is likely not an unscrupulous worker and, consequently, such HIT results can, in such an embodiment, be all deemed acceptable, including the aforementioned exemplary HIT result that was generated when the worker's behavior included the otherwise suspicious fifteen mouse click events.

While the above descriptions have been provided within the context of behavior that can be obtained through traditional user input mechanisms, such as keyboard events, mouse events, touchscreen events, or lack thereof, and other like events, in other embodiments more complex behavior logging mechanisms can be employed and, consequently, the behavior-based analysis, described in detail above, can be expanded in a like manner to include such additional logged behavior. For example, audio or video input devices that can be communicationally coupled to computing device through which the worker receives and responds to HITs can be utilized to obtain and log further types of behavior including, for example, any conversation or other like audio generated by the user, video input that can reveal where the worker's attention was focused during performance of the intelligence task, and other like behavior. As yet another example, audio or video input can likewise be referenced to verify that the intelligence task result was, in fact, performed by a human, as opposed to, for example, randomized automated mechanisms that are being unscrupulously utilized only to generate revenue without providing useful intelligence task results. Additional types of input devices can likewise be utilized to facilitate the logging of the behavior of the worker generating HIT results, including, for example, biomedical devices, fitness tracking devices, the presence or absence of wireless devices, such as cell phones or other like devices associated with a specific worker, and other input devices.

Because the logging of worker behavior can impact user privacy, explicit authorization can be obtained before any behavior is logged. A worker's failure to grant such explicit authorization, however, can be utilized to determine whether or not to assign HITs, or a specific set or subset of HITs, to such a user.

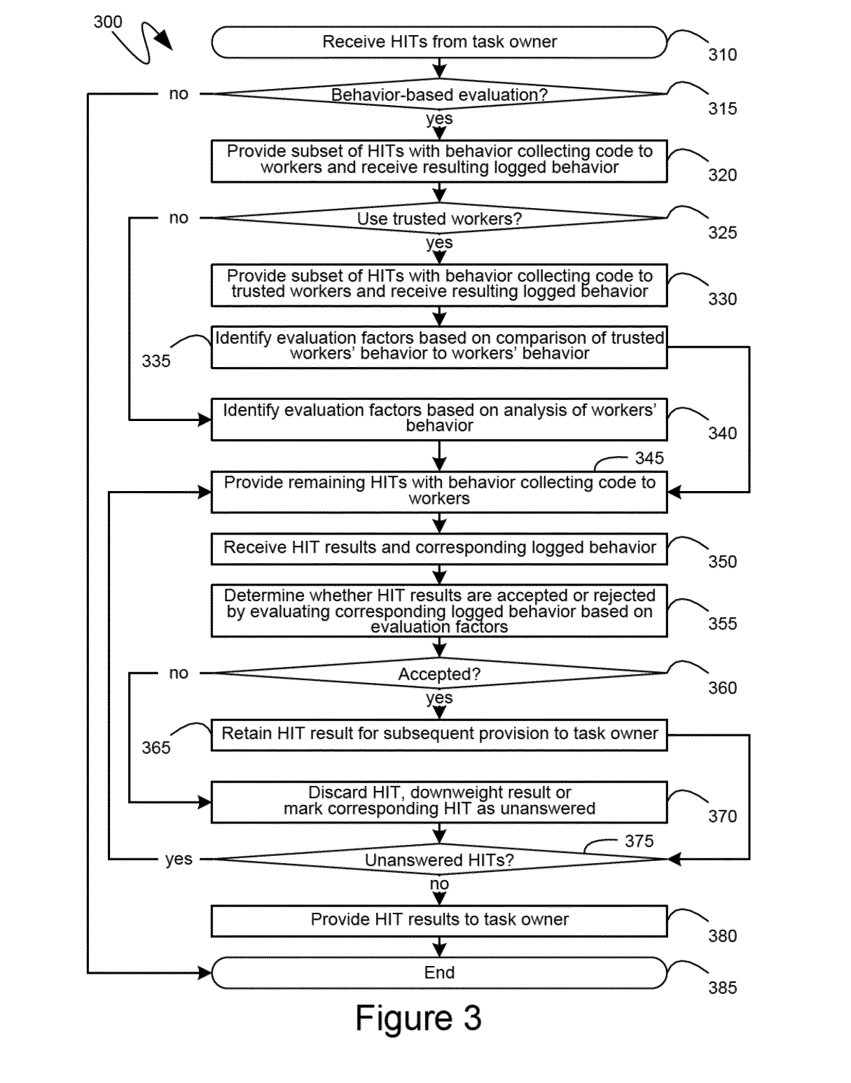

Turning to FIG. 3, the flow diagram 300 shown therein illustrates an exemplary series of steps by which a crowdsourcing system can evaluate intelligence task results based upon the behavior of the workers in generating such intelligence task results. Initially, as illustrated by the exemplary flow diagram 300 of FIG. 3, at step 310, a task, comprising individual HITs to be performed by individual workers, can be received from a task owner. Subsequently, at step 315, a determination can be made as to whether the task owner has elected to evaluate the intelligence task results being returned by individual workers based upon the behavior of those workers in generating such results. If, at step 315, it is determined that the task owner does not desire such behavior-based evaluation, processing can proceed to step 385, where the relevant processing end. Conversely, if, at step 315, it is determined that the task owner has elected to utilize behavior-based evaluation of HIT results, processing can proceed to step 320, where, optionally, a subset of the HITs can be provided to individual workers, together with mechanisms by which the behavior of such workers in performing such HITs can be observed and logged. The logged behavior, together with the intelligence task results, can then be received back from such workers.

At step 325, a determination can be made as to whether the task owner has identified trusted workers that the task owner desires to utilize to improve the behavior-based evaluation selected at step 315. If the task owner has not provided such trusted workers, processing can proceed with step 340, where the logged behavior, received at step 320, can be analyzed, such as by machine learning algorithms, to identify evaluation factors upon which to evaluate workers and the intelligence task results they generate based upon the behavior of the workers in generating such results. Processing can then proceed with step 345. Conversely, if, at step 325, it is determined that the task owner has identified trusted workers, processing can proceed with step 330, where a subset of HITs can be provided to such trusted workers, together with mechanisms by which the behavior of such trusted workers in performing such HITs can be observed and logged. As part of step 330, the logged behavior, together with the intelligence task results generated by such trusted workers, can be received from such workers. Subsequently, at step 335, the logged behavior of the trusted workers, received at step 330, can be analyzed, such as by machine learning algorithms, to identify evaluation factors upon which to evaluate workers and HIT results based upon the behavior of the workers generating such results. As indicated previously, the logged behavior of the trusted workers, received at step 330, can be treated as reference data points indicative of proper behavior in performing the corresponding HITs. Consequently, the analysis, at step 335, can take into account the differences between the logged behavior of the trusted workers, received at step 330, and the logged behavior of the workers received at step 320, in order to identify evaluation factors upon which subsequent HIT results can be evaluated based upon the behavior of the workers in generating such results.

At step 345, HITs that are part of the task received from the task owner at step 310, for which a properly generated result has yet to be received, can be provided to workers, along with mechanisms by which the behavior of such workers in performing such HITs, can be logged. The HIT results generated by such workers, together with the corresponding logged behavior, can then be received at step 350. Subsequently, at step 355, a behavior-based evaluation of the HIT results can be performed based upon the corresponding logged behavior, received at step 350, as dictated by the evaluation factors identified at either step 335 or step 340, such as in the manner described in detail above. As detailed above, the determination, at step 355, can evaluate factors individually, or in aggregate, can evaluate intelligence task results individually, or in aggregate, and can result in either a binary determination of whether to accept or reject an intelligence task result, or can result in a score, which can subsequently be evaluated to determine whether to accept or reject a intelligence task result.

Ultimately, at step 360, if it is determined, based upon an evaluation of the behavior of the worker generating the HIT result, that the result is to be accepted, than processing can proceed with step 365, and the intelligence task, together with the result, can be retained for subsequent provision to the task owner. Conversely, if, ultimately, at step 360, it is determined that the intelligence task result is suspect, than, at step 370, the corresponding intelligence task can be discarded or returned back to the collection of unanswered HITs, or the corresponding result can be downweighted, as described in detail above. Subsequent to the performance of either step 365, or step 370, determination can be made, at step 375, as to whether there are any HITs remaining for which proper results have not yet been received. If, at step 375, it is determined that such HITs remain, then processing can return back to step 345, and can proceed as described in detail above. Conversely, if, at step 375, is determined that all HITs, received from the task owner at step 310, have been properly been performed, then processing can proceed to step 380, where such intelligence task results can be returned to the task owner. The relevant processing can then end at step 385.

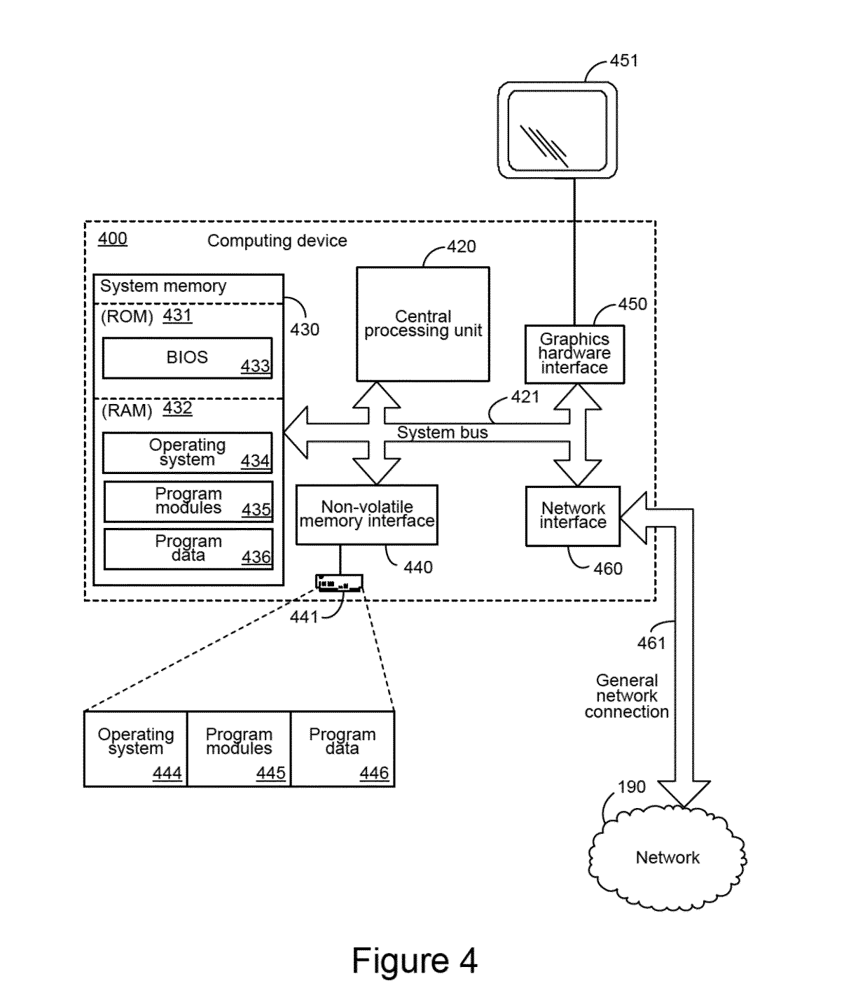

Turning to FIG. 4, an exemplary computing device 400 is illustrated which can perform some or all of the mechanisms and actions described above. The exemplary computing device 400 can include, but is not limited to, one or more central processing units (CPUs) 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. The computing device 400 can optionally include graphics hardware, including, but not limited to, a graphics hardware interface 450 and a display device 451, which can include display devices capable of receiving touch-based user input, such as a touch-sensitive, or multi-touch capable, display device. Depending on the specific physical implementation, one or more of the CPUs 420, the system memory 430 and other components of the computing device 400 can be physically co-located, such as on a single chip. In such a case, some or all of the system bus 421 can be nothing more than silicon pathways within a single chip structure and its illustration in FIG. 4 can be nothing more than notational convenience for the purpose of illustration.

The computing device 400 also typically includes computer readable media, which can include any available media that can be accessed by computing device 400 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computing device 400, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, other program modules 435, and program data 436.

The computing device 400 may also include other removable/non-removable, volatile/nonvolatile computer storage media. By way of example only, FIG. 4 illustrates a hard disk drive 441 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 441 is typically connected to the system bus 421 through a non-volatile memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers hereto illustrate that, at a minimum, they are different copies.

The computing device 400 may operate in a networked environment using logical connections to one or more remote computers. The computing device 400 is illustrated as being connected to the general network connection 461 through a network interface or adapter 460, which is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 461. It will be appreciated that the network connections shown are exemplary and other means of establishing a communications link between computing devices may be used.

Although described as a single physical device, the exemplary computing device 400 can be a virtual computing device, in which case the functionality of the above-described physical components, such as the CPU 420, the system memory 430, the network interface 460, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where the exemplary computing device 400 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executed within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

As can be seen from the above descriptions, mechanisms for evaluating intelligence task results based upon the behavior of human workers in generating such results have been presented. In view of the many possible variations of the subject matter described herein, we claim as our invention all such embodiments as may come within the scope of the following claims and equivalents thereto.

We claim:

1. A computing device for evaluating a result of an intelligence task based upon a behavior of a human worker interacting with a worker computing device to generate the result of the intelligence task, the computing device comprising one or more processing units and computer-readable media comprising computer-executable instructions that, when executed by the processing units, cause the computing device to perform steps comprising:
providing a behavior logger to log the behavior of the human worker interacting with the worker computing device to generate the result of the intelligence task;
receiving, at the computing device, the result of the intelligence task;
receiving, at the computing device, a logged behavior corresponding to the result of the intelligence task, the logged behavior being that of the human worker interacting with the worker computing device to generate the result of the intelligence task; and
evaluating, at the computing device, the result of the intelligence task based upon a portion of the logged behavior corresponding to predetermined behavioral factors.

2. The computing device of claim 1, comprising further computer-executable instructions that, when executed by the processing units, cause the computing device to perform further steps comprising downweighting the result of the intelligence task in accordance with the behavior-based evaluating.

3. The computing device of claim 1, comprising further computer-executable instructions that, when executed by the processing units, cause the computing device to perform further steps comprising removing, based on the behavior-based evaluating, the human worker from a pool of workers to whom a set of intelligence tasks is assigned, the intelligence task being one of the set of intelligence tasks.

4. The computing device of claim 1, wherein the behavior-based evaluating is informed by machine learning from prior evaluations, based on the predetermined behavioral factors, of previously received results of intelligence tasks from other human workers and corresponding logged behavior of those other human workers.

5. The computing device of claim 1, comprising further computer-executable instructions that, when executed by the processing units, cause the computing device to perform further steps comprising determining, prior to the behavior-based evaluating, the predetermined behavioral factors based on previously received results of intelligence tasks from other human workers and corresponding logged behavior of those other human workers.

6. The computing device of claim 5, wherein the intelligence tasks whose previously received results were utilized to determine the predetermined behavioral factors are intelligence tasks from a different overall task than the intelligence task whose result is being evaluated based upon the portion of the logged behavior corresponding to the predetermined behavioral factors.

7. The computing device of claim 1, comprising further computer-executable instructions that, when executed by the processing units, cause the computing device to perform further steps comprising receiving, from a trusted set of workers that are known to properly and correctly generate results for intelligence tasks, trusted results of intelligence tasks performed by the trusted set of workers and trusted logged behavior corresponding to the trusted results; wherein the behavior-based evaluating is informed by prior evaluations, based on the predetermined behavioral factors, of the trusted results and trusted logged behavior.

8. The computing device of claim 7, comprising further computer-executable instructions that, when executed by the processing units, cause the computing device to perform further steps comprising determining, prior to the behavior-based evaluating, the predetermined behavioral factors based on the trusted results and trusted logged behavior.

9. A computing device for identifying behavioral factors upon which to evaluate results of intelligence tasks, the computing device comprising one or more processing units and computer-readable media comprising computer-executable instructions that, when executed by the processing units, cause the computing device to perform steps comprising:
providing behavior loggers to log the behavior of human workers interacting with worker computing devices to generate a set of results of intelligence tasks;
providing behavior loggers to log the behavior of a trusted set of human workers interacting with trusted worker computing devices to generate a set of trusted results of intelligence tasks, wherein the trusted set of human workers are known to properly and correctly generate results for intelligence tasks;
receiving, at the computing device, a set of logged behavior being that of the human workers interacting with the worker computing devices to generate a set of results of intelligence tasks;
receiving, at the computing device, a set of trusted logged behavior being that of the trusted human workers interacting with the trusted worker computing devices to generate a set of trusted results of intelligence tasks; and
identifying the behavioral factors upon which to evaluate the results of the intelligence tasks based on a comparison of the set of logged behavior to the set of trusted logged behavior.

10. The computing device of claim 9, wherein the identified behavioral factors comprise at least one of: a quantity of mouse click events generated during generation of a result of an intelligence task, a quantity of mouse movement events generated during the generation of the result of the intelligence task, a dwell time undertaken during the generation of the result of the intelligence task, a quantity of copy-paste events generated during the generation of the result of the intelligence task and a quantity of scroll events generated during the generation of the result of the intelligence task.

11. The computing device of claim 9, wherein the identifying utilizes machine learning.

12. The computing device of claim 9, comprising further computer-executable instructions that, when executed by the processing units, cause the computing device to perform further steps comprising:
receiving, at the computing device, the set of results of intelligence tasks; and
receiving, at the computing device, the set of trusted results of intelligence tasks;
wherein the identifying the behavioral factors upon which to evaluate the results of the intelligence tasks is further based on a comparison of the set of results of intelligence tasks to the set of trusted results of intelligence tasks.

13. A method for evaluating a result of an intelligence task based upon a behavior of a human worker interacting with a worker computing device to generate the result of the intelligence task, the method comprising the steps of:
providing a behavior logger to log the behavior of the human worker interacting with the worker computing device to generate the result of the intelligence task;
receiving, at a computing device, the result of the intelligence task;
receiving, at the computing device, a logged behavior corresponding to the result of the intelligence task, the logged behavior being that of the human worker interacting with the worker computing device to generate the result of the intelligence task; and
evaluating, at the computing device, the result of the intelligence task based upon a portion of the logged behavior corresponding to predetermined behavioral factors.

14. The method of claim 13, further comprising the steps of downweighting the result of the intelligence task in accordance with the behavior-based evaluating.

15. The method of claim 13, further comprising the steps of removing, based on the behavior-based evaluating, the human worker from a pool of workers to whom a set of intelligence tasks is assigned, the intelligence task being one of the set of intelligence tasks.

16. The method of claim 13, wherein the behavior-based evaluating is informed by machine learning from prior evaluations, based on the predetermined behavioral factors, of previously received results of intelligence tasks from other human workers and corresponding logged behavior of those other human workers.

17. The method of claim 13, further comprising the steps of determining, prior to the behavior-based evaluating, the predetermined behavioral factors based on previously received results of intelligence tasks from other human workers and corresponding logged behavior of those other human workers.

18. The method of claim 17, wherein the intelligence tasks whose previously received results were utilized to determine the predetermined behavioral factors are intelligence tasks from a different overall task than the intelligence task whose result is being evaluated based upon the portion of the logged behavior corresponding to the predetermined behavioral factors.

19. The method of claim 13, further comprising the steps of receiving, from a trusted set of workers that are known to properly and correctly generate results for intelligence tasks, trusted results of intelligence tasks performed by the trusted set of workers and trusted logged behavior corresponding to the trusted results; wherein the behavior-based evaluating is informed by prior evaluations, based on the predetermined behavioral factors, of the trusted results and trusted logged behavior.

20. The method of claim 19, further comprising the steps of determining, prior to the behavior-based evaluating, the predetermined behavioral factors based on the trusted results and trusted logged behavior.
